(19) United States
(12) Patent Application Publication
(10) Pub. No.: US 2017/0145741 A1
(43) Pub. Date: May 25, 2017

(54) WINDOW BLIND HANDLE

(71) Applicant: Timothy David Palmer, Riverside, CT (US)

(72) Inventor: Timothy David Palmer, Riverside, CT (US)

(21) Appl. No.: 14/951,716

(22) Filed: Nov. 25, 2015

(51) Int. Cl. E06B 9/326; F16B 2/10

(52) U.S. Cl. CPC E06B 9/326; F16B 2/10

(57) ABSTRACT

A window blind handle comprising: a first half; a second half; a slot extending along the length of an inner surface of the first half, where the slot is adapted to receive strings of a window blind; and a lip extending along the length of an inner surface of the second half, where the lip joins and inserts into the slot when the first half and second half are placed in a closed position. The window blind handle may further include a means to connect the inner surface of the first half to the inner surface of the second half. Preferably, the means to connect includes at least one opening on the inner surface of the first half and at least one connector on the inner surface of the second half, where the at least one connector inserts into the at least one opening to join the first half to the second half.

### BACKGROUND OF THE INVENTION

Field of Invention

The present invention relates to a window blind handle that is used to control and grasp strings of a window blind.

Description of Related Art

Window blinds and blinds are commonly used as a covering on the interior of a window. The window blind or blind serves at least two functions one to shield the interior from sunlight, also to provide privacy for the user of the window blind. Window blinds are usually controlled through a dangling string that hangs from the top control pulleys of the window blind. This string allows the user to lower and raise the window blinds along the interior of the window. One drawback to the string system is that the strings may become tangled and difficult to use over time. Also it is important that the strings be moved in unison so that the blinds are moved in an evenly along the length of the window.

As a result, it would be advantageous to have a device that may be incorporated over the strings of the window to provide a single handle to manipulate the window blinds.

### SUMMARY OF THE INVENTION

The present invention relates to a window blind handle comprising: a first half; a second half; a slot extending along the length of an inner surface of the first half, where the slot is adapted to receive strings of a window blind; and a lip extending along the length of an inner surface of the second half, where the lip joins and inserts into the slot when the first half and second half are placed in a closed position. The window blind handle may further include a means to connect the inner surface of the first half to the inner surface of the second half. Preferably, the means to connect includes at least one opening on the inner surface of the first half and at least one connector on the inner surface of the second half, where the at least one connector inserts into the at least one opening to join the first half to the second half.

### BRIEF DESCRIPTION OF DRAWINGS

FIG. 1 depicts an open view of a window blind handle in accordance to the present invention.

FIG. 2 depicts the window blind handle in a closed position.

FIG. 3 depicts the use of the window blind handle attached to strings extending from a window blind.

### DETAILED DESCRIPTION

The present invention relates to a window blind handle that has attachment capabilities to the control strings of a window blind. The blind handle according to the present invention wraps around the strings and provides a composite handle for use with the window blind. The window blind handle according to the present invention helps to keep the strings in a uniform position, avoids tangling and excessive pulling in order to utilize the window blind strings.

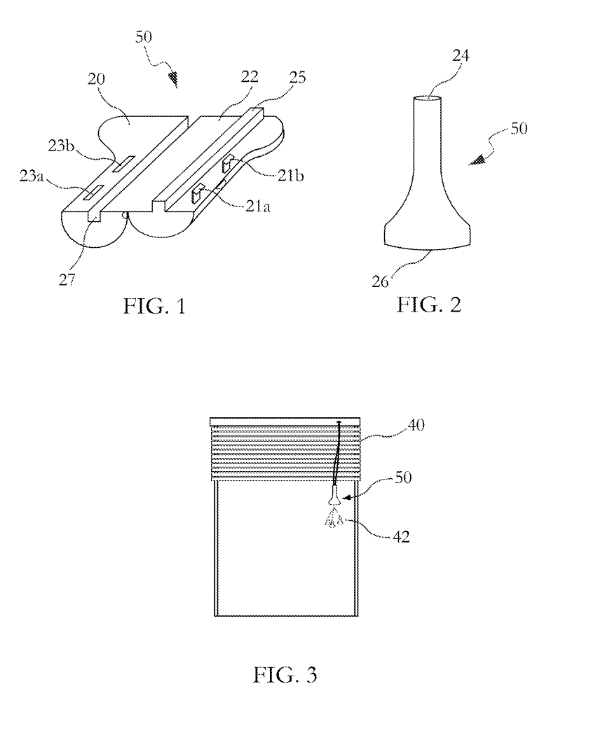

In reference to FIG. 1, a window blind handle 50 in accordance to the present invention is depicted. The handle 50 includes a first half 20 and second half 22. The blind handle 50 is shown in the open position in FIG. 1 noting the interior of mechanisms related to the blind handle 50. A slot 27 extends along the first half of the blind handle 50. Just beyond the slot 27 is two openings 23a, 23b that receive connectors 21a, 21b shown on the surface of a second half 22 of the handle 50. Further on the second half 22 is a lip 25 that inserts into the slot 27 when the handle is placed in a closed position as shown in FIG. 2.

During use, a user threads the strings of the window blind through the slot opening 27 and then closes the handle in a closed position. This placement of the strings through the handle allows the handle to maintain the strings in a uniform position during use. FIG. 3 depicts use of the blind handle 50 on a window blind 40. As shown, the window blind handle 50 extends over strings 42 that extend from the top of the window blind 40. Once in place the handle 50 allows the user to easily move and manipulate the strings as necessary to control the window blind and exposure of the window used thereon. The instant invention has been shown and described in what it considers to be the most practical and preferred embodiments. It is recognized, however, that departures may be made there from within the scope of the invention and that obvious modifications will occur to a person skilled in the art.

What is claimed is:

1. A window blind handle comprising:
a. a first half;
b. a second half;
c. a slot extending along the length of an inner surface of the first half, where the slot is adapted to receive strings of a window blind; and
d. a lip extending along the length of an inner surface of the second half, where the lip joins and inserts into the slot when the first half and second half are placed in a closed position.

2. The window blind handle according to claim 1, further including a means to connect the inner surface of the first half to the inner surface of the second half.

3. The window blind handle according to claim 2, where the means to connect includes at least one opening on the inner surface of the first half and at least one connector on the inner surface of the second half, where the at least one connector inserts into the at least one opening to join the first half to the second half.
